(19) United States
(12) Patent Application Publication
(10) Pub. No.: US 2006/0156933 A1
(43) Pub. Date: Jul. 20, 2006

(54) Servo press with elbow lever drive

(76) Inventors: Hans Hofele, Goppingen (DE); Andreas Lauke, Gruibingen (DE)

Correspondence Address: KLAUS J. BACH, 4407 TWIN OAKS DRIVE, MURRYSVILLE, PA, 15668, US

(21) Appl. No.: 11/330,434

(22) Filed: Jan. 12, 2006

(30) Foreign Application Priority Data
Jan. 14, 2005 (DE) 10 2005 001 878

(51) Int. Cl. B30B 1/10

(52) U.S. Cl. 100/281; 100/286

(57) ABSTRACT

In a press comprising a frame structure, a plunger movably supported by the frame structure, at least one servomotor for driving the plunger and an elbow lever drive connected to the servomotor and the plunger for actuating the plunger, at least one auxiliary drive is connected to the plunger for operating the plunger in stroke ranges where the elbow lever drive is ineffective for controllably moving the plunger.

### BACKGROUND OF THE INVENTION

The invention resides in a servo press with an elbow lever drive and a plunger which is movable back and forth in a predetermined direction and a servomotor for operating the elbow lever drive.

For deforming sheet metal parts, often a so-called large part stepping press is used. Such a press includes several plungers each of which is driven by eccenters via a connecting rod and the eccenters are all rotated by a common main shaft. The individual plungers are operated in phase or with a certain phase shift. The back and forth movement of the individual plunges is derived from an essentially uniform rotational movement of the main shaft.

For controlling the plunger stroke, a so-called stroke adjustment may be provided by which the effective eccentricity of the respective eccenter is adjustable. Furthermore, in place of the simple connecting rod connection between the eccenter and the plunger a lever drive may be provided which changes the normally essentially sinus-shaped plunger oscillation particularly in the vicinity of the lower dead center position of the plunger in a controlled manner.

All these solutions have in common that the travel/time curve of the plunger is not freely adjustable. Therefore servo presses have been developed wherein the plunger is operated by a servomotor via a suitable intermediate drive. Such a press is known for example from DE 41 09 796. In a first embodiment, the plunger is operated by an eccenter via a connecting rod, the eccenter being driven by a servomotor in a controlled manner. It is further proposed to arrange between the servomotor and the plunger, an elbow lever drive. With such an elbow drive, the application force can be greatly amplified particularly near the end of the stroke of the plunger.

Such servomotor-operated presses permit the provision of a reasonably variable formation of the desired distance/time curve for the plunger by a corresponding control of the servomotor. The up and down movement of the plunger is provided by backward and forward rotation of the servomotor. The stroke length can be variably adjusted herein within the geometric limits of the elbow lever drive. Also, the distance/time characteristics can be adjusted and a high press force can be generated toward the end of the plunger stroke at least in connection with elbow lever presses.

However, the achievable plunger stroke is predetermined by the elbow lever drive and, generally, is relatively small. This limits the applicability of such servo-presses with elbow lever drives.

It is therefore the object of the present invention to provide an improved servo-press with more flexible application capabilities.

### SUMMARY OF THE INVENTION

In a press comprising a frame structure, a plunger movably supported by the frame structure, at least one servomotor for driving the plunger and an elbow lever drive connected to the servomotor and the plunger for actuating the plunger, at least one auxiliary drive is connected to the plunger for operating the plunger in stroke ranges where the elbow lever drive is ineffective for controllably moving the plunger.

With the additional drive, the plunger can be further moved in a controlled manner when the elbow lever drive gets out of its controlled range into an indifference range. A controlled range is considered to be particularly that range wherein the angle enclosed between the two arms of the elbow lever drive is noticeably larger than 45°, preferably larger than 90°. When the angle between the two arms becomes pointed, particularly less than 45°, the elbow lever drive enters an indifference range. This means that, with a force effective on the hinge point of the two elbow lever arms, an accurately controlled movement of the plunger cannot be obtained. Theoretically, the transmission factor between the servomotor and the plunger in this area goes toward an infinite value. Within this indifference range, the auxiliary drive moves the plunger in a controlled manner so that it becomes possible to provide plunger strokes which cannot be controllably accommodated alone by the elbow lever drive. It is therefore possible with such servo-presses to provide for large strokes on one hand, and, on the other hand, to generate large plunger forces particularly near the end of the plunger stroke where generally the deformation work must be provided.

The power of the servomotor and of the auxiliary drive must be tuned to one another. Whereas, with conventional elbow lever drives generally only a plunger stroke can be obtained within the area of the length of one of the elbow arms, with such a combined plunger drive according to the invention larger plunger strokes can be achieved. In the extreme, the plunger stroke can equal the sum of the lengths of the two elbow arms or even greater.

The auxiliary drive is preferably a servo drive. This means that it is position controlled. There is at least one position sensor which controls the auxiliary motor via a position control circuit. In this way, the plunger movement remains controlled particularly also in the indifference area of the elbow lever drive.

The servomotor and the auxiliary drive are preferably controlled by a common control arrangement. The control arrangement preferably assigns the master role to the servomotor of the elbow lever drive, particularly in the final stroke length of the plunger when the elbow arms are almost stretched. In this area, the auxiliary drive is inactivated or acts only as a slave drive. However, when the plunger is moved toward the other end of its stroke, that is, when the elbow arms reach the area where they form an increasingly pointed angle, the control arrangement preferably assigns the guiding role to the auxiliary drive while the servomotor is assigned the role of the slave. This procedure is preferred in order to ensure that, in each case, that drive (servomotor or auxiliary motor) plays the lead role which, in the actual plunger position, applies the larger force. The switch-over point where the lead role is transferred from the servomotor to the auxiliary motor and vice-versa is then the point of force equilibrium of the two drives. But this point can also be selected to be different.

The auxiliary drive may be a drive which can provide a constant maximum force over the whole stroke of the plunger. It may be for example a servomotor which is connected to the plunger via a spindle-type drive mechanism. Alternatively, a corresponding servomotor may be connected to the plunger by way of a pull-type drive such as a toothed belt drive, a chain drive or a rope pull drive. The auxiliary drive may also be a servomotor which acts via a pinion on a gear rack which is connected to the plunger. Furthermore, the auxiliary drive may be a directly acting drive for example in the form of a linear motor, which includes a stator mounted to the press frame and a movable anchor or component which is connected to the plunger.

The auxiliary plunger drives referred to above preferably include electric motors. They can be in the form of servomotors or stepping motors. Furthermore, the electric motors may be field-controlled asynchronous-motors.

While the auxiliary drives may simply include transmissions with constant transmission ratios (such as the pull-type drives and gear rack drives etc. . . . mentioned above) also nonlinear drives may be used, that is drives whose transmission ratios are not constant. The auxiliary drive may be itself in the form of an elbow lever drive. Also the drive sources of the auxiliary drive which are preferably electromagnetic drives may use different principles. They may be for example pressure or position-controlled hydraulic drives or pneumatic drives. These drives are controllable at least to the extent that the direction of the force applied by them to the plunger can be reversed. In the most simple case, such an auxiliary drive may be a hydraulic cylinder to which a compressible or noncompressible fluid is supplied in order to move the plunger in a controlled manner against a force such as the plunger weight or another pre-tensioning structure. Such a fluid drive may be sufficient to move the plunger in a reasonably controlled manner into the indifference range of the elbow lever drive and if necessary through this range. If the main drive of the plunger formed by the servomotor as well as the auxiliary drive are both position-controlled drives, it is expedient if at least the auxiliary drive includes an elastic element by which it is connected to the plunger or to the stationary support structure. Alternatively, the auxiliary drive may itself have elastic characteristics. In this way, it is prevented that the servomotor and the auxiliary matter act rigidly against each other and are locked thereby.

Further features and advantageous embodiments of the invention will become apparent from the following description on the basis of the accompanying drawings.

### BRIEF DESCRIPTION OF THE DRAWINGS

FIGS. 1-4 show a first embodiment of a press according to the invention in different operating positions,

FIG. 5 is a schematic front view of a modified embodiment of the press according to the invention,

FIG. 6 shows another modified embodiment in a schematic front view,

FIGS. 7 to 9 show different elbow lever drive positions of the presses shown in FIGS. 1 to 6,

FIG. 10 is a graph showing the forces achievable by the press drives of FIG. 1 to 6 in a comparison diagram,

FIG. 11 shows a press according to the invention with an auxiliary elbow lever drive, and

FIG. 12 shows schematically the various kinematic states of the press shown in FIG. 11.

### DESCRIPTION OF VARIOUS EMBODIMENTS

FIG. 1 shows schematically a press 1 which comprises a press frame 2 and a plunger 3 preferably linearly movably supported therein. For guiding the plunger, there is a linear guide structure which is not shown. At the front end of the plunger 3, a top die tool 5 is attached to the plunger 3, which is part of a die 4. A lower die tool 6 is disposed on a press table 7. The deforming-tool may be a large tool for deforming sheet metal. The press 1 may be an individual unit or part of a large component stage or stepping press arrangement. Such a large component stage press arrangement may include a common press frame, in which several plungers of the type shown in FIG. 11 are movably supported. A transfer structure moves the metal sheets from press stage to press stage. Several presses of the type shown in FIG. 1 may also be set up independently of one another and interconnected by a transfer arrangement by which the metal sheets are transferred. However, the press 1 may also be a stamping tool for the deformation of a solid body. It then includes a plunger and a frame of reduced width but otherwise corresponds to the press as shown in FIG. 1.

The plunger 3 of the press 1 is connected to a drive 8 which includes at least one or more servomotors 9, 10, two being shown in the embodiment of FIG. 1. The servomotors 9, 10 are only schematically shown in FIG. 1. They are supported by a suitable support structure 11, 12 on the press frame 2 or an appropriate support means 13. The servomotors 9, 10 are position-controlled drives which are operated—position-controlled—by a control unit 14, which is only schematically shown in FIG. 1. To this end, the servomotors 9, 10 include corresponding position sensors which determine the actual position of the drive structures of the servomotors 9, 10 and supply corresponding signals to the control unit 14. The control unit 14 constantly compares the position values (actual values) with a time-dependent pre-determined desired value and, in accordance therewith, controls the servomotors 9, 10 depending on the error determined with the comparison.

The servomotors 9, 10 are for example electric motors such as asynchronous motors or DC motors. They generate a linear movement via a suitable intermediate transmission. In the present embodiment, the intermediate transmission is a spindle drive which is shown in FIG. 1 only schematically by push rods 15, 16. But the servomotors may also by hydraulic motors, for example hydraulic linear motors in the form of hydraulic cylinders with a fluid-operated piston disposed therein. The push rods 15, 16 are then piston rods.

Between the servomotors 9, 10 and the plunger 3, there are elbow lever drives 17, 18, which each have two arms 19, 20; 21, 22. The upper arms 19, 21 are pivotally supported by the press frame 2 via a top frame structure 23. The lower arms 20, 22 are pivotally connected to the plunger 3. The arms 19 and 20 and also the arms 21, 22 are interconnected in pairs by elbow joints to which also the push rods 15, 16 are connected.

The lengths of the arms 19-22 corresponds about to the plunger stroke as will be described further below.

The plunger 3 is provided with at least one auxiliary drive 24. In the embodiment shown herein, a second auxiliary drive 25 is provided. In the present embodiment, the auxiliary drives 24, 25 are linear motors whose stators 26, 27 are each connected to the press frame and whose movable anchor 28, 29 is connected to the plunger 3. The auxiliary drives 24, 25 are controlled by the control unit 24. The auxiliary drives 24, 25 may be linear stepping motors or position controlled linear motors. In the latter case, at least one position sensor is provided which reports the position of the plunger 3 to the control unit 14.

The control unit 14 is designed so as to provide for the plunger 3 almost any amount of travel/time curves with large plunger strokes. Details herefor are apparent from the following functional description:

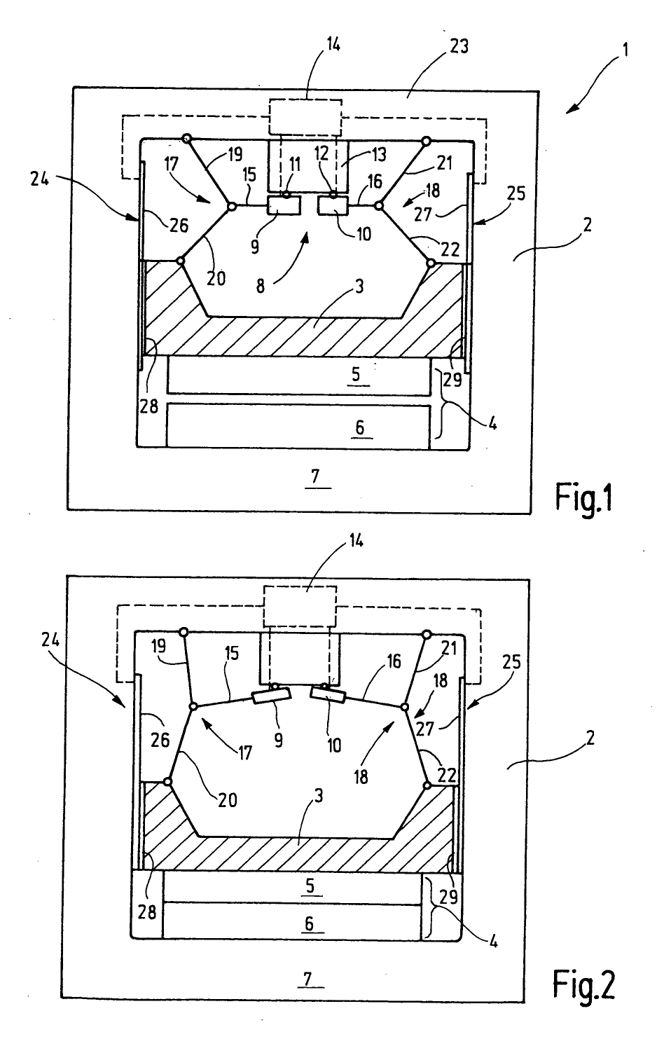

In FIG. 1, the plunger 3 is shown close to it lowers dead center position. The deforming tool 4 (die) is almost closed. In this position, the plunger 3 is preferably shortly before the end of its downward stroke. To continue the downward stroke, the control unit 14 controls the servomotors 9, 10 so that the push rods 15, 16 apply further pressure to the joints between the arms 19, 20 and, respectively, 21, 22. The elbow lever drives 18, 19 therefore stretch out further so that the plunger 3 is moved to the position as shown in FIG. 2. As a result of the smaller motion transmission ratio of the elbow lever drive, substantial pressure forces are generated. During the whole operating stroke, the auxiliary drives 24, 25 may be active and generate a downwardly directed force. But the auxiliary drives 24, 25 may also be inactivated at least near the lower dead center position of the plunger 3.

When the plunger 3 is to be moved upwardly from its lower dead center position as shown in FIG. 2, the servomotors 9, 10 are reversed. Their rods 15, 16 then generate a pulling force on the joints between the arms of the elbow lever drive 17, 18. The auxiliary drives 24, 25 are also reversed so as to generate an upwardly directed force. Alternatively, they may be left inactivated.

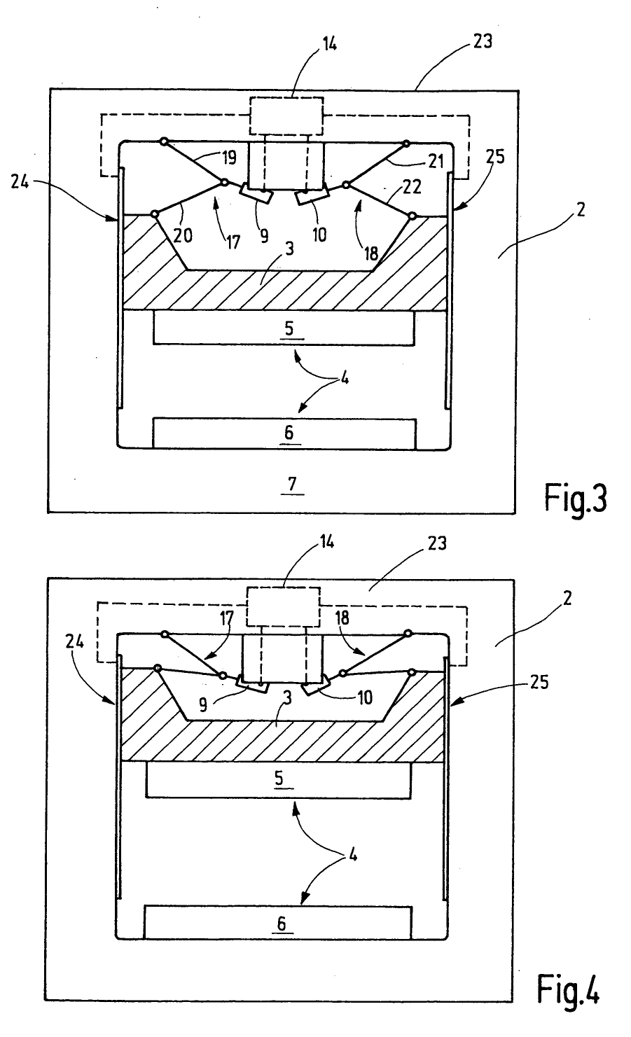

By the action of the servomotors 9, 10, the plunger 3 then moves out of the position shown in FIG. 2 to the position shown in FIG. 1, whereby the die 4 opens. Continued pulling of the servomotors 9, 10 at the pivot joints of the elbow drives 17, 18 causes further upward movement of the plunger 3 whereby the die 4 is further opened. The auxiliary drives 24, 25 which were active from the start or were activated in the meantime support the upward movement of the plunger 3. In the position as shown in FIG. 3, the arms 19, 20 and 21, 22 are disposed at pointed angles. In this range, the elbow lever drives 17, 18 lose substantial lifting force and the position control of the plunger becomes inaccurate because of the large transmission ratios of the movement of the servomotors relative to the movement of the plunger 3. Movement of the plunger by the servomotors 9, 10 therefore becomes difficult. The respective section of the stroke of the plunger is therefore called the indifference range. In this indifference range, the plunger position is not longer precisely determined by the position of the service motors 9, 10. Further movement of the plunger 3 is therefore accomplished by the auxiliary drives 24, 25 by which the plunger 3 can be moved upwardly beyond the position shown in FIG. 3, for example, to the position as shown in FIG. 4. Consequently, by cooperation of the servomotors 9, 10 and the auxiliary drives 24, 25, a controlled plunger stroke can be obtained which is substantially larger than the stroke achievable alone by the servomotors 9, 10 and the elbow lever drives 17, 18.

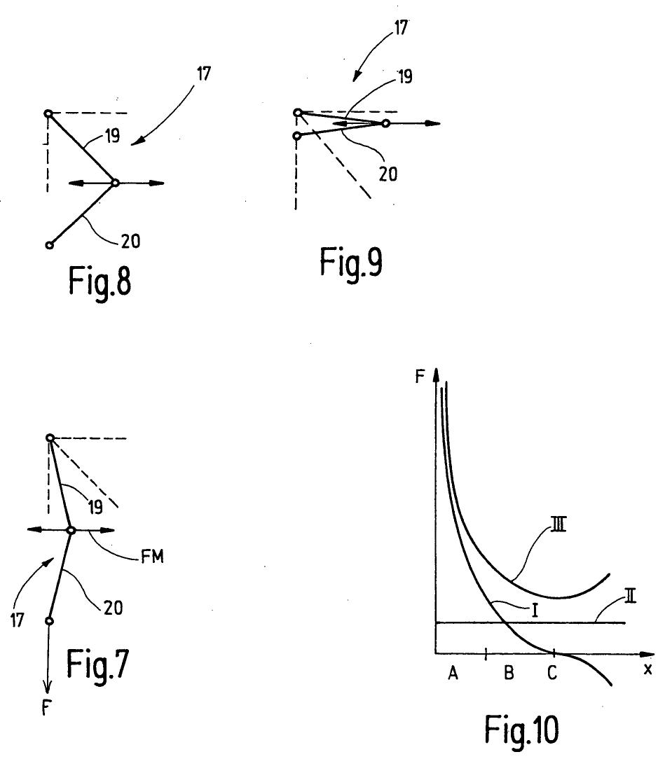

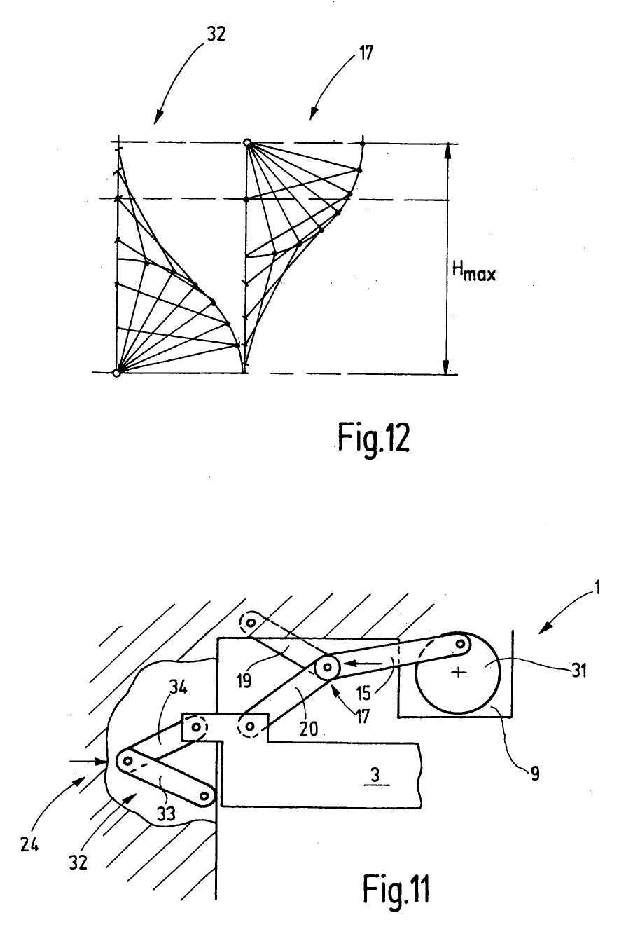

The FIGS. 7 to 10 show the kinematic conditions and the force relationships at the elbow lever drive or, respectively, the plunger. FIG. 7 shows the elbow lever drive 17—also representative for the elbow lever drive 18—in an almost stretched position near the lower end position of the plunger stroke. In this position, the angle between the arms 19, 20 is substantially larger than 90°, but smaller than 180°. In this range, forces FM effective on the pivot joint of the arms are converted to very large plunger forces F. FIG. 10 shows this force depending on the plunger position. The curve I indicates the plunger force F generated by a constant drive force FM. As shown very large forces F are generated for a lower section A of the plunger stroke.

FIG. 8 shows the conditions at the elbow lever drive 17 at increasing distance of the plunger 3 from its lower dead center position. The arms 19, 20 form about a right angle. As a result, the motion transmission reduction between the servomotor and the plunger decreases and becomes a motion increase. Accordingly, the force transmitted to the plunger by the elbow lever drive drops in accordance with the curve I as shown in the range B of FIG. 10. If the elbow lever drive 17 is further folded as shown in FIG. 9, the angle enclosed by the arms 19, 20 becomes very small and the force F approaches zero as indicated by the curve I.

In order to move the plunger 3 in the range B in a controlled manner, the auxiliary drive 24, 25 provides an additional force acting on the plunger 3 which is shown in FIG. 10 by the curve II. In this example, the force of the auxiliary drive 24 is independent of the position of the plunger 3. Effective on the plunger 3 is therefore, the sum of the forces applied by the elbow lever drive 17 and by the auxiliary drive 24 according to the curve III. Since also the forces of the auxiliary drives 23, 26 are effective on the plunger 3, the whole distance x marked by the ranges A and B can be utilized. If necessary, the stroke could even be increased beyond the range A+B if the elbow lever structure 17 is designed to permit flapping over, that is, if the arms are pivotable not only by an angle of 90°, but by a larger angle. The servomotors 9, 10 could then be reversed in order to support further upward movement of the plunger 3, whereby the curve III would again curve upwardly past the point C. In the end point C of the range B, the angle between the arms 19, 20 is zero.

With the combination of servomotor operated elbow lever drive and auxiliary drive as described above any type of distance/time curve can be established for the plunger movement; in the area of the lower dead center position very high press forces can be generated and also large plunger strokes can be obtained. Also, the plunger speeds can be very high, particularly in the upper area of the plunger stroke where the forces on the plunger are relatively small.

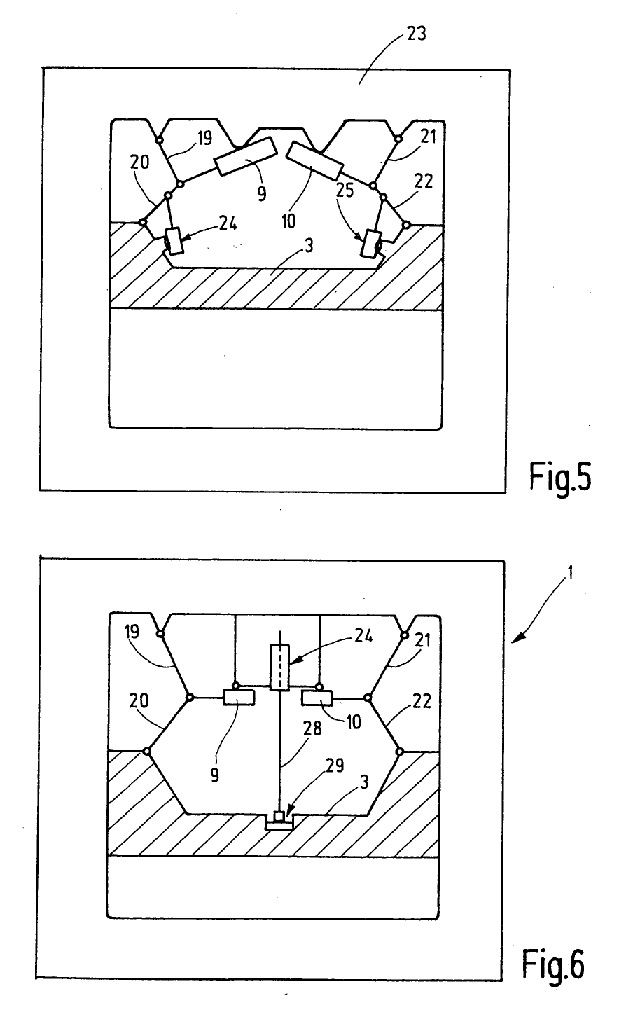

In the embodiment as described above, it is assumed that the servomotors 9, 10 act on the elbow pivot joints of the elbow lever drives 17, 18. However, the servomotors 9, 10 may also be connected to other points of the arms 19, 21 or the arms 20, 22. In the latter case, the servomotors 9, 10 could be mounted to the plunger 3. But the servomotors 9, 10 could also be torque motors acting on one of the pivotal support points of the arms 19, 21, that is, at the frame member 23 or at the plunger 3. Furthermore, it is assumed in the above description that the auxiliary drives 24, 25 are effective between the press frame 2 and the plunger 3. But it is also possible to mount the auxiliary drives on the plunger 3 as shown in FIG. 5. The auxiliary drives 24, 25 could then be electric or pneumatic linear drives acting on the arms 20, 22.

Furthermore, the auxiliary drives 24 could be in the form of spindle actuators whose operating spindle 28 is connected for example to a central location of the plunger 3 (FIG. 6). In order to avoid that the servomotors 9, 10 and the auxiliary drive 24 block one another, the operating spindle 28 may be connected to the plunger via a spring element 29. The operation of the press 1 is as described earlier so that the auxiliary drive 24 which controls the plunger movement in the upper part of the stroke of the plunger 3 is activated in the upper part of the stroke but preferably over the whole stroke range and provides either an auxiliary upward or downward force depending on the direction of movement of the plunger 3. At least in the upper range of the plunger stroke, the auxiliary drive 21 also determines the position of the plunger 3. In the lower part of the plunger stroke when the arms 19, 20 or respectively, 21, 22, extend at angles greater than 90° relative to each other the servomotors 9, 10 take over the generation of the forces and the positioning of the plunger whereas the auxiliary drive 24 is only idling or follows as a slave drive. It is also possible that the servomotors 9, 10 and the auxiliary drive 24 and possibly the additional auxiliary drive 25 switch their roles as masters and slave depending on which drive generates in a particular travel section, the larger plunger operating force. For example, the servomotors 9, 10 may act as master servomotors in the lower stroke range where the angle between the arms 19, 20 is clearly larger than 90° while the auxiliary drive 24 acts as master drive in the upper stroke range of the plunger 3 when the arms 19, 20 enclose an angle smaller than 90°.

The auxiliary drives 24, 25 are preferably drives with linear operating characteristics that is, with a constant transmission ratio between the respective drive motor and the plunger 3. However, already the embodiment of FIG. 5 deviates from this principle, that is, such an arrangement is not necessary.

The auxiliary drive may also be in the form of an elbow lever drive. Such an embodiment of the press 1 is shown in FIG. 11. The servomotor 9 in this embodiment operates the elbow lever drive 17 via an eccenter 31 or a crank and transmits the force to the elbow lever drive 17 by way of a drive rod 15. The auxiliary drive 24 includes an elbow lever drive 32, which is arranged in a sense opposite to the elbow lever drive 17. For example, the frame-based pivot support joint for an arm 33 which is part of the elbow lever drive 32 may be disposed below the plunger 3. Then the elbow lever drive 24 is extended when the elbow lever drive 17 is folded and vice versa. The elbow lever drive 24 may be operated by a servomotor or a similar drive which acts on the pivot joint between the arms 33, 34. FIG. 12 shows the kinematics for the elbow lever drives 17, 32. As apparent, a maximum stroke Hₘₐₓ corresponding to the length of the two arms 19, 20 and 33, 34 can be obtained.

The servo-press according to the invention includes as plunger drive a servomotor operated elbow lever drive 17 whereby large deformation forces as well as an essentially free choice for the plunger travel/time curve is available. At least one auxiliary drive additionally acts on the plunger in order to expand the controllably range of the plunger stroke beyond that which can be controlled the elbow lever drive. The auxiliary drive 24 is preferably position-controlled and controlled by the control unit 11 which also controls the operation of the elbow lever servo drive. As a result, large strokes can be obtained. This permits the application of such presses in areas which have so far not been considered for such presses.

What is claimed is:

1. A press comprising a frame structure (23) a plunger (3) supported in the frame structure (23) so as to be movable back and forth at least one servomotor (9) for driving the plunger (3), an elbow lever drive (17) connected to the servomotor (9) and the plunger (3) for actuating the plunger (3) and at least one auxiliary drive (24) connected to the plunger (3) so as to be capable of operating the plungers in stroke ranges where the elbow lever drive (17) is ineffective for controllably moving the plunger (3).

2. A press according to claim 1, wherein the auxiliary drive (24) is a servo-drive.

3. A press according to claim 1, wherein the servomotor (9) and the auxiliary drive (24) are controlled by a common control unit (14).

4. A press according to claim 1, wherein the plunger (3) has a lower stroke range and an upper stroke range and, in the lower stroke range, the plunger (3) is operated by the servomotor (9) via the elbow lever drive (17) and in the upper stroke range, the plunger (3) is operated by the auxiliary drive (24).

5. A press according to claim 1, wherein the auxiliary drive (24) has a maximum plunger operating force in the upper plunger stroke range.

6. A press according to claim 1, wherein the auxiliary drive (24) has a plunger operating force which is constant over the whole plunger stroke length.

7. A press according to claim 1, wherein the auxiliary drive (24) has elastic support characteristics.

8. A press according to claim 7, wherein the auxiliary drive (24) is connected to at least one plunger (3) and the frame support structure (23) by way of an elastic element.

9. A press according to claim 1, wherein the elbow lever drive (17) has an indifference range (B) in an area where the arms (19, 20, 21, 22) of the elbow lever drive (17) are disposed relative to each other at an angle of less than 90° and the plunger (3) is operable into that indifference range by the auxiliary drive (24).

10. A press according to claim 1, wherein the elbow lever drive (17) has an indifference range (B) in an area where the arms (19, 20, 21, 22) of the elbow lever drive (17) are disposed relative to each other at an angle of less than 90° and the plunger (3) is operable through that indifference range by the auxiliary drive (24).

11. A press according to claim 1, wherein the servomotor (9, 10) is a linear drive.

12. A press according to claim 1, wherein the servomotor (9, 10) is connected to the elbow lever drive at the elbow joint thereof.

13. A press according to claim 1, wherein the auxiliary drive (24) is an electric linear motor (26, 26a).

14. A press according to claim 1, wherein the auxiliary motor (24) is a position-controlled linear drive.

15. A press according to claim 1, wherein the auxiliary motor (24) is a hydraulic fluid drive.

16. A press according to claim 1, wherein the auxiliary motor (24) is a spindle drive.

17. A press according to claim 1, wherein the auxiliary motor (24) is a pull drive.

18. A press according to claim 1, wherein the auxiliary motor (24) is an elbow lever drive.
